(19) United States
(12) Patent Application Publication
(10) Pub. No.: US 2019/0040843 A1
(43) Pub. Date: Feb. 7, 2019

(54) METHOD FOR DETERMINING WIND SPEED AND PLANT FOR PERFORMING SAID METHOD

(71) Applicant: UPTIME HOLDING GMBH, Graz (AT)

(72) Inventors: Christopher GRAY, Thal (AT); Franz LANGMAYR, Graz (AT)

(73) Assignee: UPTIME HOLDING GMBH, Graz (AT)

(21) Appl. No.: 16/084,476

(22) PCT Filed: Jan. 4, 2017
(86) PCT No.: PCT/AT2017/060001

§ 371 Date: Sep. 12, 2018

(30) Foreign Application Priority Data
Mar. 16, 2016 (AT) GM 50045/2016

(51) Int. Cl. F03D 7/04; F03D 17/00

(52) U.S. Cl. CPC F03D 7/048; F03D 17/00; F05B 2270/802; F05B 2270/321; F05B 2240/96

(57) ABSTRACT

The invention relates to a method for determining a wind speed in a plant (1) having at least two wind turbines (2) spaced apart from one another. In order to determine the wind speed with high accuracy, it is provided according to the invention that an occurrence of a change in the local wind speed is detected for the at least two wind turbines (2), whereupon at least one time difference by which the local changes at the at least two wind turbines (2) are offset is determined, whereupon the wind speed is determined based on the time difference and a distance (3) between the wind turbines (2). In addition, the invention relates to a plant (1) having at least two wind turbines (2) spaced apart from one another.

The invention relates to a method for determining a wind speed in a plant having at least two wind turbines spaced apart from one another.

The invention furthermore relates to a plant having at least two wind turbines spaced apart from one another.

Different methods for determining the wind speed in wind farms have become known from the prior art. Typically, the wind speed is thereby measured by means of an anemometer attached to a wind turbine, or ultrasonically on a rotor hub. However, measurements of this type are inaccurate, since the measurement always takes place at isolated points in a turbulent flow region. What is relevant for a closed loop control of wind turbines, however, is an average wind speed in a region through which rotor blades of the wind turbine pass during one revolution.

Wind speeds determined using methods from the prior art are therefore only of limited significance for a closed loop control of the wind turbines. In addition, in order to perform methods from the prior art, measurement devices are required which are both costly and also maintenance-intensive.

This is addressed by the invention. The object of the invention is to specify a method of the type named at the outset that can be used to achieve a particularly meaningful measurement result.

Furthermore, a plant of the type named at the outset is to be specified for performing a method of this type.

According to the invention, the first object is attained with a method of the type named at the outset, wherein an occurrence of a change in the local wind speed is detected for the at least two wind turbines, whereupon at least one time difference by which the local changes at the at least two wind turbines are offset is determined, whereupon the wind speed is determined based on the time difference and a distance between the wind turbines.

Over the course of the invention, it was discovered that a speed of wind gusts, and therefore a wind speed, can be determined in a corresponding plant in an extremely simple manner, in that local changes in the wind speed are detected at the individual wind turbines and a generally known distance between the wind turbines is divided by the time difference by which the changes in the wind speed at the individual wind turbines are offset. The wind speed thereby obtained corresponds to the speed at which the wind gust or flow discontinuity is propagated within the flow field of the plant between the individual wind turbines, or to a speed of a front with a higher speed that flows through the plant. In contrast to measurement results determined using methods from the prior art, a measurement result thus does not solely correspond to a wind speed at isolated points, as a consequence of which the measurement result is significantly more meaningful and can be more readily used for the closed loop control of the wind turbines or the entire plant.

A change in the local wind speed at a wind turbine can be detected using a wide range of different methods and apparatuses known from the prior art, including conventional anemometers or the like, for example.

It is beneficial if the occurrence of a change in the local wind speed follows from a measurement of a state variable of the wind turbine that is dependent on the wind speed, in particular a power output generated by wind. Since the wind speed is determined in the method according to the invention by detecting a propagation of a change in the wind speed, an exact determination of the local absolute wind speed at the individual wind turbines is not necessary. In order to detect a change in the local wind speed, basically any state variable of the wind turbine that is dependent on the wind speed can be used, even if an exact relation between the absolute wind speed and the respective state variable is not known. For example, a change in the local wind speed can thus follow from the measurement of a sound level or the determination of mechanical loads on components of the wind turbine, or from changes in these state variables. In this manner, the detection of a change in the local wind speed can, for example, occur through the detection of changes in mechanical stresses or accompanying changes of deformations in a mast, rotor blades or parts of a drive train on the wind turbine. Among other things, a generator torque can thus also be used as a state variable for the detection of a changed wind speed, since changes in the wind speed can cause a changed generator torque.

Up to a wind speed of approximately 12 m/s, a change in the wind speed normally has an effect on a change in a rotor speed on wind turbines from the prior art, so that at least over a range up to the noted wind speed, a rotational speed of the rotor can also be used to detect changes in the wind speed. Wind-speed fluctuations with a particularly high frequency are typically attenuated by an inertia of the wind turbine rotor, which acts as a low-pass filter, so that a highly meaningful measurement result is achieved. At higher wind speeds, a closed loop control is typically used to change a blade pitch angle, in order to avoid rotor speeds that lie above a defined rotational speed. Therefore, the controlled blade pitch angle can also be used as a state variable for detecting a change in the wind speed.

To determine the time difference in the case of continuous measuring signals for state variables of at least two wind turbines, a correlation of the state variables can be determined, for example, by analyzing one signal against the other signal and deriving therefrom the time difference by which the arrival of fluctuations in the wind speed at the downstream wind turbine is delayed. The wind speed results directly from the time difference and the distance between the wind turbines, so that particularly in the case of a continuous of state variables, a determination of the wind speed is even possible with slight fluctuations in the wind speed using the method according to the invention.

Even though the method can also be carried out with low strength wind gusts, it is beneficial if a particularly strong wind gust flows through the plant, since an impact of said wind gust on individual turbines can be detected with particular accuracy, so that a change in state variables, for example, power output changes, on the individual wind turbines can be attributed to a wind gust. However, it can also be provided that changes in state variables of the individual wind turbines, which variables are used to determine a change in the local wind speed, are for example compared in terms of amplitude and period in order to identify corresponding changes that are caused by the same wind gust. The method can thus also be carried out when multiple gusts of wind flow through a plant in brief intervals and in different directions.

In addition, electrical state variables can also be used to detect a local change in the wind speed, which variables are dependent on the wind speed or correlate with the wind speed, in particular an electrical power output generated by the wind turbine.

The detection of a local change in the wind speed using a change in the electrical power output generated by the wind turbine has proven particularly effective for performing the method, since the power output generated on wind turbines is generally measured anyway, and since the generated power output also exhibits a strong correlation with an average of the local wind speed on an area through which rotor blades of the wind turbine pass during one revolution.

Since the wind speed in the method according to the invention is determined using a time difference between the impact of a wind gust on wind turbines spaced apart from one another and a spacing of the wind turbines, an accuracy of the measurement is dependent on an accuracy of the determination of the time difference and on an accuracy with which the distance between the wind turbines is incorporated into the calculation. The distance between the wind turbines can, for example, be determined with high accuracy using laser measurement technology. Particularly in the case of tall wind turbines, a deflection of a mast has a significant effect on a distance between the wind turbines. On identical wind turbines, an identical deflection will also take place at an identical wind speed, for which reason the effect of a mast deflection on the distance between the wind turbines is negligible for identical wind turbines.

Where different types of wind turbines are used, potential deviations in rigidities of the individual types, or different mast deflections resulting therefrom, can of course also be taken into account arithmetically.

It is clear that an effect of an inaccuracy when determining the time difference has a smaller influence on an accuracy of the measurement result as the distance between the wind turbines increases.

In order to be able to determine the wind speed with high accuracy in typical wind farms, in which a distance between individual wind turbines is approximately 100 m, it is beneficial if the state variable is measured continuously or at a sampling frequency of more than 0.1 Hz, in particular more than 1 Hz, preferably more than 10 Hz, Thus, at a wind speed of roughly 10 m/s, a low measuring error of approximately 2% is achieved if adjacent wind turbines spaced approximately 100 m apart from one another are used to determine the wind speed. If a higher accuracy is to be achieved, the sampling frequency can also be greater. Furthermore, wind turbines spaced very far apart from one another can be used to achieve a particularly high accuracy.

If the power output is used as a state variable to detect a local change in the wind speed, the power output therefore must be measured using appropriate measuring technology at the aforementioned frequency in order to achieve the desired accuracy. Typically, a change in power output occurs in a delayed manner compared to a change in the wind speed. A delay can be caused, for example, by an inertia of components of a drive train on the wind turbine. The delay with which a change in the local wind speed thus has an effect on a change in the power output generated by the turbine is normally identical for wind turbines of the same type, and can therefore be ignored. If wind turbines of a different type are used, or wind turbines with which different delays occur between a change in the local wind speed and a change in power output, these differing delays can also be taken into account arithmetically when determining the time difference, in order to achieve a high measurement accuracy.

It is beneficial if measurement results are stored and a relation between the wind speed and at least one state variable of the wind turbine is established from multiple measurement results. In this manner, a determination of the wind speed using the established relation or a discovered correlation between the state variable and the wind speed is possible even if the wind speed does not change or no disturbances are propagated in a flow field of the plant. For example, by analyzing a mathematical relation between multiple wind gusts having a different wind speed and the increases in power output thereby caused on the individual wind turbines, a relation between a wind speed and a generated power output, or a correlation function, can be derived, so that the wind speed can subsequently be determined at each individual wind turbine based on the measured power output by means of the correlation function.

If a relation of this type has been derived from multiple measurement results, it is therefore beneficial if the state variable is measured and the wind speed is determined using the measured state variable and the relation between the wind speed and the state variable. The wind speed can thus be determined with high accuracy in a continuous manner.

Advantageously, more than two wind turbines are used, in order to determine a direction of the wind speed. Typically, wind turbines in a wind farm, or in a plant, are arranged in a uniform distribution. By integrating multiple, preferably all, wind turbines of a plant, it is possible to derive a propagation direction of the wind gust very effectively from the points in time at which a wind gust reaches the individual wind turbines. The direction of the wind gust identified in this manner can, especially if a relation between the measured wind speed and the state variable, for example the power output of a wind turbine, is determined, be taken into account if a propagation direction of the wind gust deviates from a dominant wind direction in the flow field, as a result of which the wind turbines aligned with the dominant wind direction are not optimally aligned with respect to the wind gust.

The other object is attained by a plant of the type named at the outset in which an occurrence of a change in a local wind speed can be detected for the at least two wind turbines, wherein a time difference by which the local changes in the wind speed at the individual wind turbines are offset can be measured, and wherein a data processing device is provided with which the wind speed can be determined by dividing a distance between the wind turbines by the time difference.

With the division of the known distance between the wind turbines and the determined time difference, it is thus possible to easily derive a wind speed of the flow discontinuity between the wind turbines, at which wind speed the flow discontinuity or a disturbance within a flow field of the plant is propagated.

It is beneficial if the change in the wind speed at the wind turbines is possible by measuring a state variable of the wind turbine that is dependent on the wind speed, in particular a generated power output of the wind turbine.

To determine the wind speed with particularly high accuracy, it is advantageous if the state variable can be measured continuously or at a sampling frequency of more than 0.1 Hz, in particular more than 1 Hz, preferably more than 10 Hz. Typically, a device for determining the generated power output of the wind turbine is provided, with which device the power output can be measured at a corresponding frequency.

To allow the wind speed to be determined with the plant according to the invention even when no disturbance of the flow field is propagated in the wind turbine, it is advantageous that a data storage for storing multiple measurement results and a data processing system are provided, wherein a relation between the measured wind speed and a state variable of the wind turbine can be determined from multiple measurement results with the data processing system. Using a relation determined in this manner, or a correlation function or correlation coefficient, a wind speed can also be determined in the case of a non-fluctuating disturbance by clearly deriving a wind speed from a state variable, such as a currently generated power output.

Advantageously, a data storage is provided in which a mathematical relation between the wind speed and a state variable of the wind turbine, in particular a generated power output, is stored so that a current wind speed can be determined based on the measured state variable using the mathematical relation. The mathematical relation can be a correlation coefficient or a correlation function in order to allow a current wind speed to be directly derived from a measured state variable, such as a measured power output.

It is advantageous if more than two wind turbines are provided which are positioned such that different propagation directions of wind gusts within the plant can be detected. For this purpose, the wind turbines are generally not positioned along a straight line. Preferably, multiple wind turbines are arranged in a uniform distribution in multiple directions in order to allow a particularly accurate detection of propagation directions of wind gusts.

Additional features, advantages and effects of the invention follow from the exemplary embodiment illustrated below. The drawings which are thereby referenced show the following:

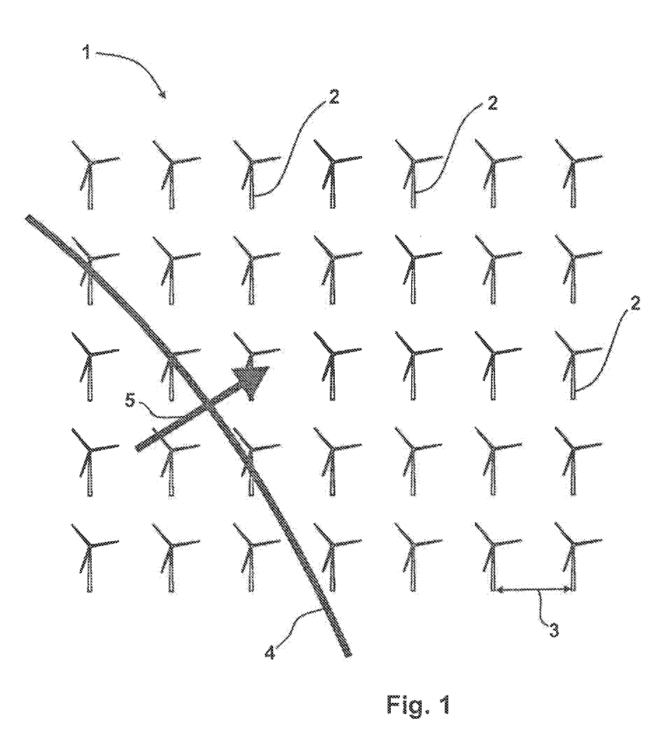

FIG. 1 A plant having multiple wind turbines;

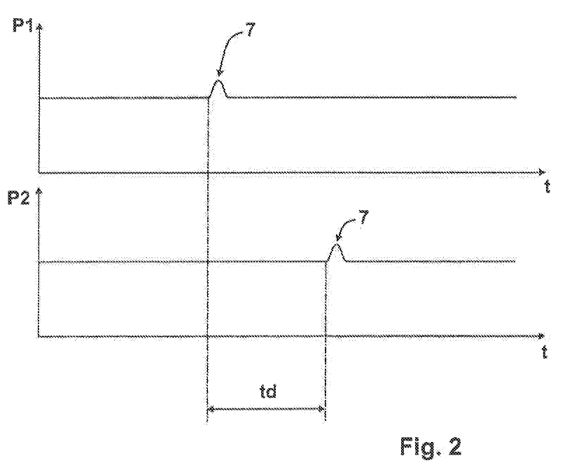

FIG. 2 Schematic power output trends of multiple wind turbines from the plant illustrated in FIG. 1.

FIG. 1 shows a plant 1 having multiple wind turbines 2 arranged in a uniform distribution, which plant is also referred to as a wind farm. A distance 3 between the individual wind turbines 2 is roughly 100 m. A front 4 of a wind gust and a propagation direction 5 of the same are schematically illustrated. The wind gust has a higher wind speed than a stationary flow field of the plant 1 and reaches the individual wind turbines 2 at different points in time depending on a position of the turbines. A time difference td by which the arrival of the front 4 at adjacent wind turbines 2 is delayed is thereby dependent on a distance 3 between the adjacent wind turbines 2, as well as the wind speed and the propagation direction 5 of the wind gust.

FIG. 2 shows chronological trends of measured power outputs of two adjacent wind turbines 2 from the plant 1 illustrated in FIG. 1. As can be seen, the power output trends exhibit chronologically offset, temporary power output increases 6 having an identical period and amplitude, which increases are caused by a passing of the wind gust. From a time difference td by which the power output increases 6 at the individual wind turbines 2 are offset, and from a known distance 3 between the wind turbines 2, a speed of the wind gust can be derived. Here, the time difference td can follow in an automated manner, for example, by determining the points in time at which the individual power outputs exhibit maximum values and establishing the time difference td between these points in time. Furthermore, from the wind speed determined in this manner and a maximum power output value during the power output increase 6, it is possible to derive a relation between the wind speed and the power output of the wind turbine 2 with the currently determined wind speed.

In addition, the plant 1 comprises a data storage and a data processing system, which are not illustrated. In the data storage, data for various measurements, for example, determined wind speeds, maximum power outputs of the wind turbines 2, and increases or the derived time of the generated power output during the passing of a wind gust, can be stored so that a relation or a correlation between the measured power output, or a derivation of the same, and the measured wind speed can be established. Using this relation, or the determined correlation, a wind speed can subsequently be determined with the data processing system even if no disturbance or wind gust is propagated in the flow field of the plant 1. As a result, a measurement of the wind speed with high accuracy, for example, is possible based on the measurement of power output.

With a method according to the invention, a highly accurate measurement of a wind speed in a wind farm is possible without additional measuring devices being necessary to do so, whereby a maintenance cost of the plant 1 is reduced. In fact, conventional devices for measuring wind speed can be omitted, so that an anemometer, for example, is no longer required for a measurement of the wind speed during operation.

The wind speed is preferably determined using the measured power output, so that the wind speed is not measured merely at isolated points as with methods from the prior art, but rather the wind speed effectively acting on the rotor can be determined. Through the use of more than two wind turbines 2 that are not arranged in a line, an accurate determination of the direction of the wind gust can also be made. In addition, using a comparison of the power output increases 6 at the individual wind turbines 2 for the same wind gust, data concerning a quality of the individual wind turbines 2 can be gathered and compared. In particular, a smaller power output increase 6 at one wind turbine 2 compared with upstream and downstream wind turbines 2 can indicate a need for maintenance on that wind turbine 2.

Since presently installed wind farms or wind turbines 2 in wind farms are generally equipped with a device for determining the output power generated, the method can also be carried out at particularly low cost on existing plants 1 in order to determine the wind speed with high accuracy and at a reduced maintenance cost.

Existing devices for measuring wind speed, such as anemometers or ultrasonic measurement devices, can of course also continue to be used, and can be calibrated using the method according to the invention. This is particularly advantageous in the case of low wind speeds or low temperatures, since devices from the prior art frequently exhibit low accuracy in ambient conditions of this type. By contrast, high accuracies are achieved even at low speeds with the method according to the invention. An in situ calibration of this type is essentially possible without additional effort, so that costs can be reduced compared to typical calibration methods.

1. A method for determining a wind speed in a plant (1) having at least two wind turbines (2) spaced apart from one another, characterized in that an occurrence of a change in the local wind speed is detected for the at least two wind turbines (2), whereupon at least one time difference (td) by which the local changes at the at least two wind turbines (2) are offset is determined, whereupon the wind speed is determined based on the time difference (td) and a distance (3) between the wind turbines (2).

2. The method according to claim 1, characterized in that the occurrence of a change in the local wind speed follows from a measurement of a state variable of the wind turbine (2), which state variable is dependent on the wind speed, in particular a power output generated by wind.

3. The method according to claim 2, characterized in that the state variable is measured continuously or at a sampling frequency of more than 0.1 Hz, in particular more than 1 Hz, preferably more than 10 Hz.

4. The method according to claim 1, characterized in that measurement results are stored and a relation between the wind speed and at least one state value of the wind turbine (2) is established from multiple measurement results.

5. The method according to claim 4, characterized in that the state value is measured and the wind speed is determined using the measured state value and the relation between the wind speed and the state value.

6. The method according to claim 1, characterized in that more than two wind turbines (2) are used in order to determine a direction of the wind speed.

7. A plant (1) having at least two wind turbines (2) spaced apart from one another, in particular for performing a method according to claim 1, characterized in that an occurrence of a change in a local wind speed can be detected for the at least two wind turbines (2), wherein a time difference (td) by which the local changes in the wind speed at the individual wind turbines (2) are offset can be measured, and wherein a data processing device is provided with which the wind speed can be determined by dividing a distance (3) between the wind turbines (2) by the time difference (td).

8. The plant (1) according to claim 7, characterized in that the change in the wind speed at the wind turbines (2) is possible by measuring a state variable of the wind turbine (2) that is dependent on the wind speed, in particular a generated power output of the wind turbine (2).

9. The plant (I) according to claim 7, characterized in that a data storage for storing multiple measurement results and a data processing system are provided, wherein a relation between the measured wind speed and a state variable of the wind turbine (2) can be determined from multiple measurement results with the data procession system.

10. The plant (1) according to of claim 7, characterized in that a data storage is provided in which a mathematical relation between the wind speed and a state variable of the wind turbine (2), in particular a generated power output, is stored so that a current wind speed can be determined based on the measured state variable using the mathematical relation.
